(19) United States
(12) Patent Application Publication
(10) Pub. No.: US 2013/0086473 A1
(43) Pub. Date: Apr. 4, 2013

(54) CENTRAL ACCESS LAUNCH CENTER FOR WEB BASED SCENARIOS

(71) Applicants: Stefan Faust, Mannheim (DE); Erik Luengen, Heilbronn (DE)

(72) Inventors: Stefan Faust, Mannheim (DE); Erik Luengen, Heilbronn (DE)

(73) Assignee: SAP AG, Walldorf (DE)

(21) Appl. No.: 13/251,156

(22) Filed: Sep. 30, 2011

(51) Int. Cl. G06F 3/01

(52) U.S. Cl. 715/708

(57) ABSTRACT

A computer system includes instructions recorded on a computer-readable medium and that are executable by at least one processor. The system includes a message generation module configured to generate and send an electronic message containing a selectable link, the selectable link being unique to an identified prospective customer and to enable access to a remotely hosted, on-demand computer application. The system includes an interface module configured to present an interface to the identified prospective customer in response to receiving a selection of the selectable link contained in the electronic message, where the interface includes an information area and a selection area having one or more selectable uniform resource locators (URLs), where each of the URLs points to a demonstration scenario in the on-demand computer application and each of the URLs is a same URL for each different identified prospective customer.

### TECHNICAL FIELD

This description relates to a central access launch center for web based scenarios including, for example, demonstration scenarios and demonstration systems.

### BACKGROUND

Many businesses may provide computer applications and software for use by customers. In many cases, it may be challenging for a business to allow prospective customers to test the computer applications and software to determine whether or not to become an actual customer. It is desirable to find new ways to provide access to prospective customer to computer application offerings in a manner that is reliable and efficient.

### SUMMARY

According to one general aspect, a computer system includes instructions recorded on a computer-readable medium and that are executable by at least one processor. The system includes a message generation module configured to generate and send an electronic message containing a selectable link, the selectable link being unique to an identified prospective customer and to enable access to a remotely hosted, on-demand computer application. The system includes an interface module configured to present an interface to the identified prospective customer in response to receiving a selection of the selectable link contained in the electronic message, where the interface includes an information area and a selection area having one or more selectable uniform resource locators (URLs), where each of the URLs points to a demonstration scenario in the on-demand computer application and each of the URLs is a same URL for each different identified prospective customer. The system includes an access module configured to grant access to the selected demonstration scenario located on the remotely hosted server in the on-demand computer application in response to receiving a selection of one of the selectable URLs and an on-demand module configured to utilize the on-demand computer application to run the demonstration scenario.

In another general aspect, a computer-implemented method for allowing prospective customers of a remotely hosted, on-demand computer application to test the on-demand computer application includes generating and sending an electronic message containing a selectable link, the selectable link being unique to an identified prospective customer and to enable access to a remotely hosted, on-demand computer application, where the remotely hosted, on-demand computer application includes a suite of applications on at least one remotely hosted server that is accessible by multiple different users from different entities at a same time. In response to receiving a selection of the selectable link contained in the electronic message, an interface is presented to the identified prospective customer, where the interface includes an information area and a selection area including one or more selectable uniform resource locators (URLs), where each of the URLs points to a demonstration scenario in the on-demand computer application and each of the URLs is a same URL for each different identified prospective customer. In response to receiving a selection of one of the selectable URLs, access is granted to the selected demonstration scenario located on the remotely hosted server in the on-demand computer application and the on-demand computer application is utilized to run the demonstration scenario.

In another general aspect, a computer-readable storage medium stores instructions that, when executed, cause a processor to perform a process, the instructions comprising instructions to perform the method described in the general aspect above.

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary schematic diagram of a launch center.

FIG. 2 is an exemplary screen shot of a launch center interface.

FIG. 3 is an exemplary screenshot of a demonstration scenario.

FIG. 4 is an exemplary schematic diagram of an interface.

FIG. 5 is an exemplary screenshot of an interface.

FIG. 6 is an exemplary screenshot of an interface.

FIG. 7 is an exemplary screenshot of a draft electronic message.

FIG. 8 is an exemplary block diagram.

FIG. 9 is an exemplary flowchart of an exemplary process.

### DETAILED DESCRIPTION

This disclosure describes systems and techniques for allowing prospective customers of a remotely hosted, on-demand computer application to test the on-demand computer application. This disclosure describes systems and techniques related to providing access to a launch center for potential or prospective customers to enable the potential customers to access the on-demand computer application. The prospective customers may experience the on-demand computer application through one or more demonstration scenarios. The demonstration scenarios may include access to a live on-demand system that hosts the on-demand computer applications. The demonstration scenarios also may include an interactive click through process recording that provides the prospective customer with a more structured experience of the on-demand computer application. A launch center may be used as a central access point to the demonstration scenarios.

This document also describes systems and techniques to enable one or more different types of invitations to be sent to invite prospective customers to access the on-demand computer application. For example, in one exemplary implementation, an authorized user of the on-demand computer application may use a requestor module to invite prospective customers for a trial access to the on-demand computer application. In another exemplary implementation, an interested customer may arrange for access to the launch center through their own setup and invitation. In this manner, different manners of enabling invitations to the launch center may be arranged by an interested person or by an authorized user on behalf of someone else.

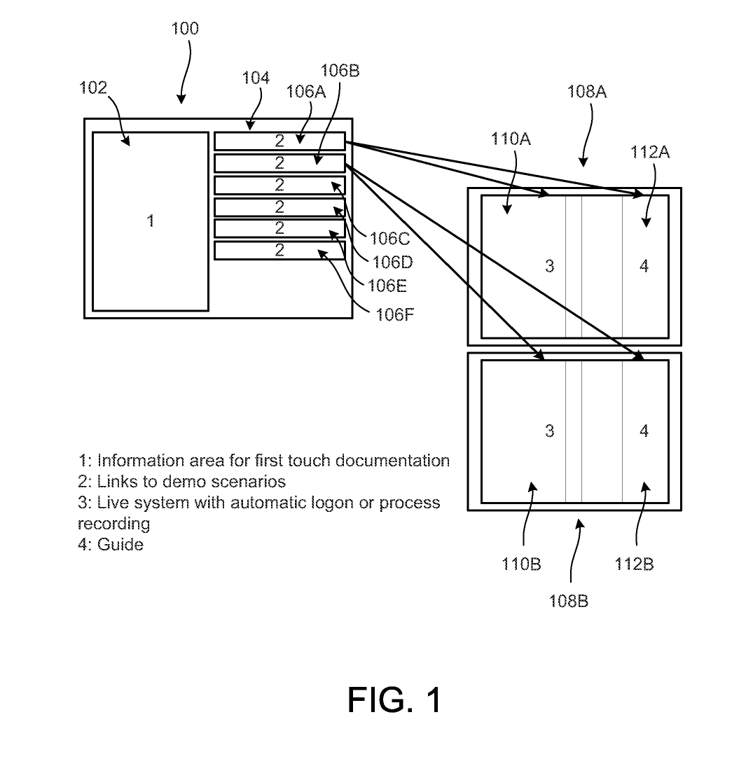

Referring to FIG. 1, an exemplary schematic of a launch center 100 is illustrated. The launch center 100 includes an information area 102 and a selection area 104. The information area 102 may include a window or a frame that is part of a website. The launch center 100 also may be referred to as an interface 100. The interface 100 provides the launch pad for a prospective customer to access one or more of the demonstration scenarios. The interface may be hosted on a server. The interface may be a webpage that provides both the information area 102 and the selection area 104.

In some implementations, the information area 102 and the selection area 104 may be on the same webpage with different frames of the webpage being designated for the information area 102 and the selection area 104. The arrangement of the information area 102 and the selection area 104 on the interface 100 may be in different arrangements other than what is illustrated in the example of FIG. 1. The illustration of the interface 100 in FIG. 1 is merely an example illustration of the arrangement of the information area 102 and the selection area 104.

The interface 100 is arrived at by a prospective customer from the selection of a link or uniform resource locator (URL) that is provided to the prospective customer either in an electronic message that is received by the prospective customer as part of an invitation or through the generation of the link through signing up on a website associated with the on-demand computer application. In one exemplary implementation, the interface 100 may include a themed interface such that the information area 102 and the selection area 104 are related by a common theme to promote the testing of the on-demand computer application. The interface 100 is a first screen that enables a user to access the on-demand computer application through the interface 100.

The information area 102 may include information such as, for example, documentation, audio information, printed information, an embedded video containing information, or other types of information related to the testing and accessing of the on-demand computer application through the use of the demonstration scenarios. The interface 100 provides and/or acts as a gateway to the actual on-demand computer application that is to be used for testing and gaining a hands-on experience by prospective customers. The interface 100 provides access to the actual computer application that is used by multiple different users from different entities at a same time. The different users accessing the on-demand computer application include other prospective customers as well as authorized users and customers of the on-demand computer application. In this manner, prospective customers get to experience the actual on-demand computer application that is in use by current authorized customers.

The selection area 104 may include one or more selectable links 106A-106F. The selectable links 106A-106F may be uniform resource locators (URLs), where each of the URLs points to a demonstration scenario in the on-demand computer application. Each of the selectable links 106A-106F may point to a different demonstration scenario. The selectable links 106A-106F may be a same selectable link used by each different identified prospective customer. In this manner, multiple different prospective customers may use the same selectable links to access the same on-demand computer application and the same demonstration scenarios located on the remotely hosted computer. The on-demand computer application supports multiple different users accessing the same application at a same time. In this manner, enabling access is made more user-friendly and easier to allow many prospective customers to access the same applications and to use the same test data.

The selectable links 106A-106F each may point to a different demonstration scenario located on a remotely hosted server. On-demand means that the computer application, which may include a suite of computer applications (also referred to as a suite of computer software applications), that is always running and accessible by multiple different users. Authorized users may access the same application or instances of the same application, but use their own personal information and personal data, which is segregated and secure from other users of the same system. While all of the users may access the same applications or instances of the applications, each authorized user may only access their specific data that is used within the applications. In the case for prospective customers, the data may be the same test data that is accessed by each of the different prospective customers. The prospective customers may be using the same computer application as other prospective customers and as well as other authorized users.

The selectable links 106A-106F may be identified in text by a particular demonstration scenario. For example, a demonstration scenario may include one or more different types of business scenarios that a prospective customer may encounter in running a business application. The underlying URL may be hidden from view and not displayed in the selection area and instead the text of the particular business scenario would be displayed instead. A selection of one of the links brings the user to the on-demand computer application associated with the particular demonstration scenario.

A selection of one of the selectable links 106A-106F brings the prospective customer to the selected demonstration scenario located on the remotely hosted server in the on-demand computer application. For example, as illustrated in FIG. 1, a selection of the link 106A grants access to the selected demonstration scenario and opens the demonstration scenario 108A on the user's computer. A selection of the selectable link 106B would open the corresponding demonstration scenario 108B on the user's computer.

In one exemplary implementation, only one demonstration scenario may be selected and opened at a time. In other exemplary implementations, multiple demonstration scenarios may be selected and open at a same time. The selection of one of the links grants access to the selected demonstration scenario without requiring a user identification and/or a password. In this manner, the granting of access is made more seamless to prospective customers since a specific user identification and password is not required. In contrast, authorized users and actual customers typically require the use of a user identification and a password to enable access to the on-demand application and access to their specific data for use in the on-demand application. Since the prospective customers are using test data, then the user identification and password are not needed, even though the prospective customer is accessing the same on-demand application as other prospective customers, as well as authorized users. The selection of one of the links provides an automatic log-on process to the on-demand computer application that is located on a remotely hosted server or other computing device.

The demonstration scenario may include one or more different types of application areas. For example, one demonstration scenario may provide access to an application area, such as application area 110A, that is configured to provide live access to the on-demand application. The application area 110A may provide access to actual live processes as part of the demonstration scenario and that utilizes the test data within the live system. As discussed above, access is granted to the selected demonstration scenario and the application area 110A that is the same particular on-demand computer application that may be accessed and used by other authorized customers and/or prospective customers. The demonstration scenario also may be referred to as a business scenario.

One exemplary purpose of the live system is to serve as a proof point to a prospective customer and show the live interaction with aspects of the system that are not scripted and that can be delivered on a live hosted software solution. The live system may be a weakly guided access that lets the prospective customer experience the on-demand computer application on their own with the possibility to leave the guide and to access other parts of the system according to their own interest.

In another exemplary implementation, the demonstration scenario 108A may provide an interactive process recording that simulates the on-demand application within an application area 110A. The interactive process recording may be a pre-recorded and scripted simulation of a particular demonstration or business scenario that includes guided fields that are open for input. Particular fields within the application are highlighted to indicate where the prospective customer should select to continue the simulation. The interactive process recording option reduces any issue of underlying system performance and removes the possibility of the prospective customer wandering or changing data during their simulation experience.

In some instances, a same demonstration scenario may be either a live system access in which the user may step through the demonstration at their own pace as well as leaving the particular area to explore other areas of the application or the demonstration scenario may be an interactive process recording. The determination of whether the particular demonstration scenario is a live access scenario or an interactive process recording may be made the registration and selection of the scenarios by the prospective customer on sign-up or by a referral from an authorized user on behalf of the prospective customer.

Each demonstration scenario may include one or more windows or frames. The arrangement of the windows or frames may change and are not intended to affect the scope of this application. For example, the demonstration scenario 108A may include an application area 110A and a guide area 112A. The demonstration scenario 108B may include an application area 110B and a guide area 112B. The application area 110A or 110B is configured to provide either live access to the on-demand application and/or provide access to an interactive process recording to simulate the on-demand application. Either the live access or the interactive process recording may be limited in one or more ways by the particulars of the demonstration scenario and/or the limits of the test data provided to run as part of the demonstration scenario. In many cases, the application area provides the actual on-demand application to the user in order that the prospective customer may experience firsthand an interaction with the actual on-demand application. While the selectable links 106A-106F may be a same link for each prospective user, a selection of the link by more than one user may create multiple instances of the application area and the guide area on each user's own computer.

The guide area 112A or 112B may include information and click-through steps to assist the prospective customer in using the application area 110A or 110B. In one implementation, the guide area 112A or 112B includes text information and hints on how to perform a particular process that is part of the demonstration scenario. In other exemplary implementations, the guide area 112A or 112 B may include an audio voice-over in order to provide additional information to the prospective customer or to increase accessibility to the particular demonstration scenario being displayed in the application area 110A or 110B.

In one exemplary implementation, both the application area 110A and the guide area 112A may be displayed at a same time on a same screen. In other exemplary implementations, the application area 110A and the guide area 112A may be displayed on separate screens or in separate windows. For example, the application area 110A may be displayed and a link or an expansion link may be provided in place of the guide area 112A. Upon selection of the expansion link, the guide area may be maximized or open and displayed alongside the application area 110A. In other cases, a selection of the expansion link or maximizing the guide area may open a new window or a new screen for the guide area 112A. In other exemplary implementations, the guide area also may include other interactive media such as, for example, other audio files and video files and links to other information, which may aid the prospective customer in their experience while using the application area 110A.

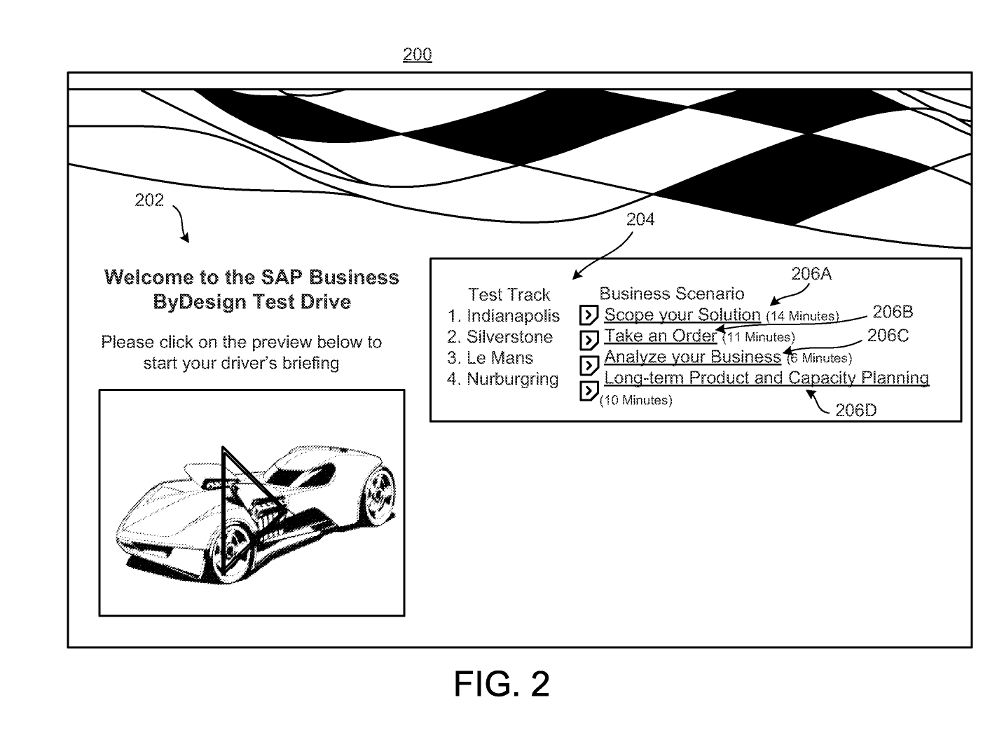

Referring to FIG. 2, an exemplary screenshot illustrates an interface 200. The interface 200 is a screenshot of a launch center. The interface 200 is arrived at by a prospective user receiving an electronic message that includes a selectable link. The selectable link is unique to the identified prospective customer and, upon selection, enables access to the interface 200. The interface 200 may be part of the on-demand computer application that is located on the remotely hosted server. The on-demand computer application may include a suite of applications that are on at least one remotely hosted server that is accessible by multiple different users from different entities at a same time. The on-demand computer application means that the applications are located on a remotely hosted server and are accessible for use by multiple different users from multiple different locations at a same time. The applications that are accessed allow the users to use the applications with their own personal data, which also may be stored in a database on either the same or a different remote server accessible by the on-demand application.

In this example, the interface 200 includes an information area 202 and a selection area 204 containing multiple selectable links 206A-206D that each point to a different demonstration or business scenario. The information area 202 corresponds to the information area 102 of FIG. 1, as discussed above. The selection area 204 corresponds to the selection area 104 of FIG. 1. The selectable links 206A-206D corresponds to the selectable links 106A-106D of FIG. 1.

In this example, the information area 202 includes a multimedia presentation that describes and provides information related to the use and selection of the different demonstration scenarios. This exemplary implementation also includes a theme related to test driving the business applications, where the prospective user is referred to as a driver and each of the different business scenarios are referred to as test tracks, as illustrated by the different labeled test tracks in the selection area 204. The information area 202 also may include other types of multimedia and/or other information that is not illustrated in this example.

The selection area 204 includes multiple selectable links 206A-206D. Each of the selectable links 206A-206D represents a different business scenario. For example, the selectable link 206A relates to a “scope your solution” demonstration scenario. The selectable link 206A includes an underlying URL that, when selected, points the user and grants access to the user's computer to the particular demonstration scenario.

The selectable link 206B represents a demonstration scenario related to taking an order, such as a purchase order or a sales order in a business scenario. The selectable link 206B includes an underlying URL that points to the demonstration scenario on the on-demand application related to taking an order.

The selectable link 206C relates to a demonstration scenario to analyze your business. The selectable link 206C includes an underlying URL that points to the demonstration scenario related for analyzing your business.

The selectable link 206D relates to a demonstration scenario for long-term product and capacity planning The selectable link 206D includes an underlying URL related to the long-term product and capacity planning demonstration scenario.

Each of the selectable links 206A-206D may be a same for each demonstration scenario that is presented to other prospective customers. In this manner, the setup of the different demonstration scenarios is made more uniform and easily implemented because the same underlying URL is used for multiple different users. While each prospective customer may have a unique selectable link that brings them to the interface page 200, once on the interface 200 each of the selectable links 206A-206D in the selection area 204 may be a same across multiple different prospective customers.

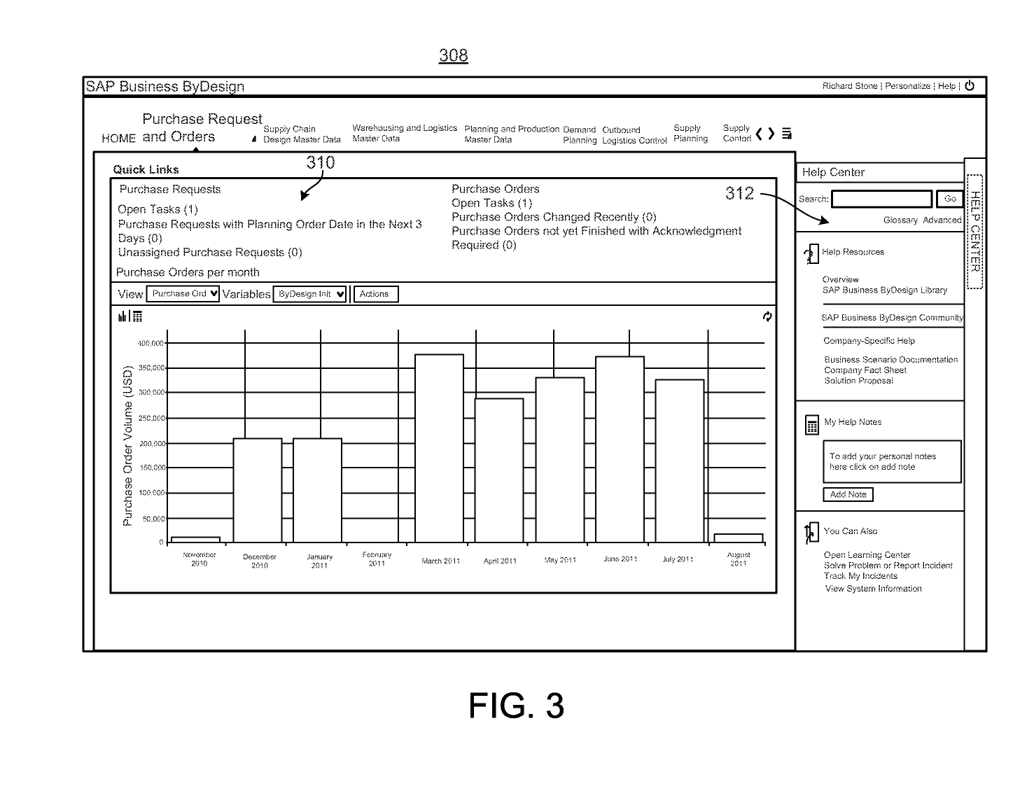

Referring to FIG. 3, an exemplary screenshot illustrates the demonstration scenario 308. The demonstration scenario 308 may be arrived at by the user selecting one of the selectable links 206A-206D of FIG. 2. For example, if the user selects the selectable link 206B to take an order, then access to the selected demonstration scenario 308 may be granted to the user. The URL may open the demonstration scenario 308 on a user's browser application on their computing device. The demonstration scenario 308 may correspond to the demonstration scenario 108A or 108B of FIG. 1. The demonstration scenario 308 may include an application area 310 and a guide area 312. The application area 310 may correspond to the application area 110A or 110B of FIG. 1. The guide area 312 may correspond to the guide area 112A or 112B of FIG. 1.

In one exemplary implementation, the application area 310A may be configured to provide live access to the on-demand application so that the user may experience the demonstration scenario related to taking an order. As can be seen from the exemplary screenshot, the application area relates to purchase requests and orders. The application area 310 utilizes the live on-demand computer applications to run the demonstration scenario using test data. The user may be allowed to select any or all of the links or other application processes related to taking an order. The application area 310 provides the user with an actual experience of the actual software and what it would be like to use the on-demand application in this particular business setting. This enables the prospective customer to get a feel for what it is like to use the actual application.

The guide area 312 may provide information and/or other resources that help the user in using the demonstration scenario being displayed in the application area 310. In some exemplary implementations, as discussed above, the guide area 312 may be part of the same window on the same page as the application area 310. In other exemplary implementations, the guide area may be a separate window including, for example, a pop-up window or a hidden window that is expandable upon selection. The guide area 312 may include a help center, help resources, help notes, and other selectable links to learn more about the particular computer application. The help resources may include an overview, access to a library and other resources as well as community and specific help, as can be seen from the descriptive links provided on the demonstration scenario 308.

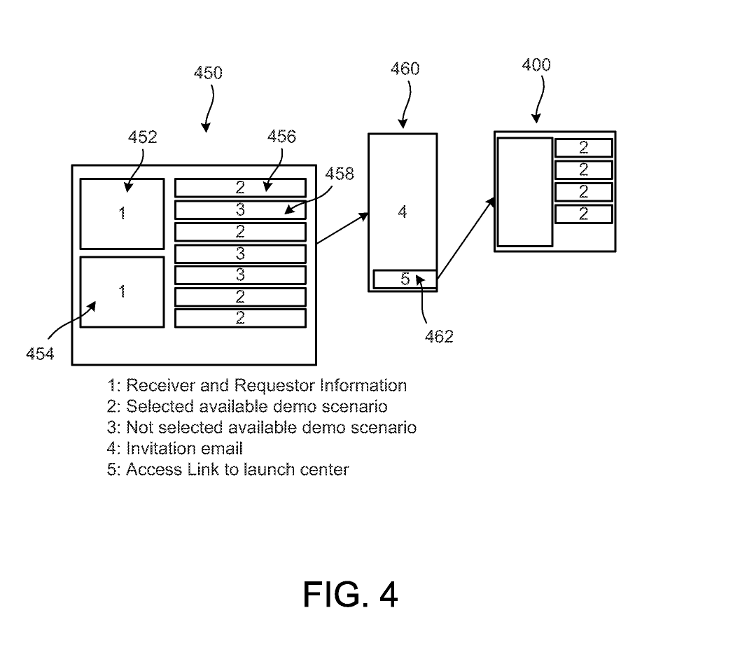

Referring to FIG. 4, an exemplary schematic illustrates an interface 450 to provide authorized customers and/or prospective customers with a selection of one or more demonstration scenarios that causes the generation and sending of an electronic message 460 with a selectable link 462 to access the demonstration scenarios. In this manner, an interface is provided to allow authorized users and prospective customers to register for access to the demonstration scenarios.

In one exemplary implementation, a user may navigate to a website that may include a link related to testing of the on-demand application. A selection of that link may point the user's browser to the interface 450. The interface 450 is an exemplary template showing the areas on the interface and the information that each of the areas may include. In one exemplary implementation, an application programming interface (API) may be associated with a website and a link on the website that causes the generation of the interface 450.

The interface 450 may include a receiver area 454 and a requestor area 452. The receiver area 454 may include multiple fields that allow the requestor to enter relevant information about the receiver or the prospective customer to enable the generation of a link to allow access to the on-demand application. For example, the receiver area 454 may include fields such as, for example, a first name, a last name, a phone number, and/or an email address. The fields also may include a confirmation email address field to ensure that the correct email address has been input by the requestor.

The requestor area 452 may include one or more fields in order to take down the personal information related to the requestor. In one exemplary implementation, the requestor may be an authorized user. In other exemplary implementations, the requestor may be the same person as the receiver.

The interface 450 includes one or more fields to allow the requestor to select one or more demonstration scenarios. In one exemplary implementation, the fields 456 may include a drop-down menu with the list of demonstration scenarios that are available for selection. Other fields, such as fields 458, may include demonstration scenarios that are not available for selection.

In one exemplary implementation, different demonstration scenarios may be made available depending on whether the requestor is an authorized user or an interested person, who may have accessed the interface 450 through a public website. For example, the menu in the fields 456 may be limited based on how the requestor accessed the interface 450. An API may be used to determine which demonstration scenarios may be made available depending on the manner in which the interface 450 was accessed. The requestor may select one or more demonstration scenarios. The requestor also may select an order in which the demonstration scenarios are to appear in the electronic message that is sent to the prospective customer. The interface 450 may include a submission button that, when selected, causes the generation in sending of an electronic message, such as electronic message 460. The submission through the interface 450 may only be accomplished if the required information is filled out in the fields 452, 454 and 456 in the appropriate manner.

The API may be used to generate the electronic message 460. The electronic message 460 may include a standard form message to the prospective user that is personalized using the information from one or more of the receiver field 454 and the requestor field 452. The electronic message 460 may be different types of electronic messages including, for example, an email, a text message, and/or other type of electronic message.

The electronic message 460 may include a selectable link 462. The selectable link 462 may be a unique link that is unique to the identified prospective customer. The selectable link enables access to the remotely hosted, on-demand computer application. Upon selection of the selectable link 462, the interface 400 is provided to the prospective customer. The interface 400 corresponds to the interface 100 of FIG. 1.

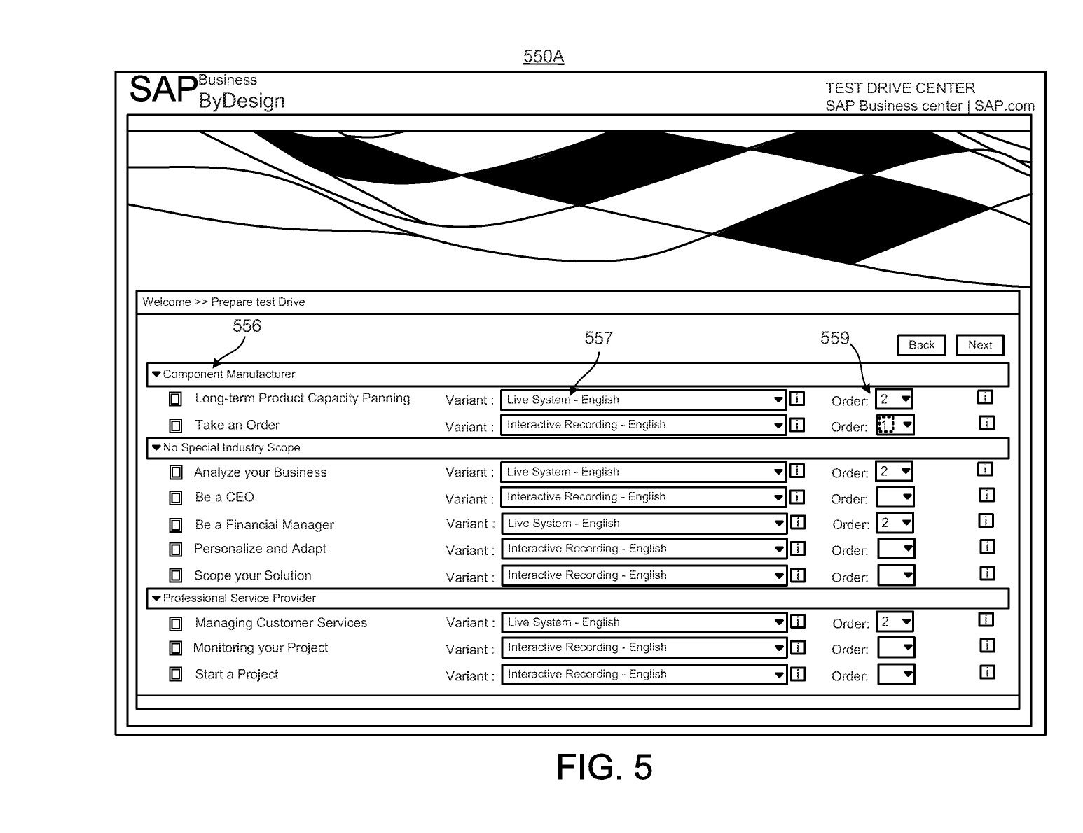

Referring to FIG. 5, an exemplary screenshot illustrates the interface 550 to enable the selection of one or more demonstration scenarios for an identified prospective customer. In this example, the interface 550 provides a list of multiple different demonstration scenarios for selection to present to a prospective customer and the selectable links to access the demonstration scenarios on the on-demand computer application. The interface 550 may be presented to an authorized user and/or to a interested user in a self-service mode. The interface 550 includes one or more selectable areas 556 representing the potential demonstration scenarios available for the customer.

In this example, the demonstration scenarios are broken out into different groups such as, component manufacturer, no special industry scope, or professional service provider. Within each of these breakdowns, check boxes are presented for each of the demonstration scenarios. Along with the demonstration scenarios 556, the interface 550 also includes a variant selection 557. The variant selector allows the requestor to select whether the demonstration scenario should be on the live system or an interactive process recording. The variant selector also may include other options in a drop-down menu such as, for example, the language in which the demonstration scenario should be presented. In some instances, the demonstration scenario may be limited to either the live system or to the interactive process recording.

The interface 550 also includes an order selector 559. The order selector allows the requestor to select the order in which the demonstration scenarios will appear in the electronic message that is sent to the receiver. In some implementations, a limited number of demonstration scenarios may be selected. In other exemplary implementations, all of the demonstration scenarios may be selected for presentation as selectable links to the identified customer.

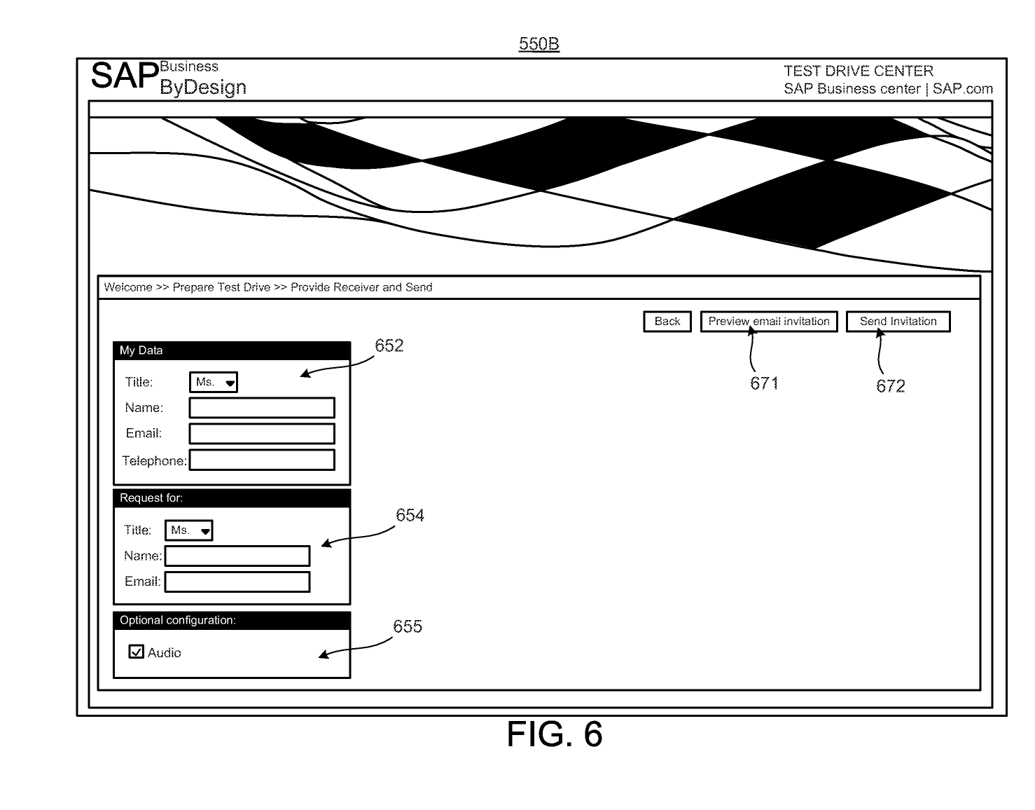

Referring to FIG. 6, an exemplary screenshot illustrates the interface 550B. The interface 550B includes the requestor area 652 and the receiver area 654. The interface 550B may be part of the same screen or interface as interface 550A of FIG. 5. In other exemplary implementations, the interface 550B may appear on a separate screen or a next step from the interface 550A. The requestor area 652 corresponds to the requestor area 452 of FIG. 4. The receiver area 654 corresponds to the receiver area 454 of FIG. 4. The requestor and receiver areas 652 and 654 include one or more fields to submit and enter the data related to the requestor and the receiver including, for example, a name, an email, and a telephone field.

The interface 550B also includes an optional configuration area 655. The optional configuration area 655 includes optional settings such as audio and/or other multimedia configurations that may be presented to the user in the electronic message or along with the various demonstration scenarios. Upon completion of the requestor and receiver areas, the user may select the preview in email invitation button 671 or may directly send the invitation 672. The send invitation button 672 generates an electronic message using the information from the requestor and the receiver fields and sends an email to the receiver using the email field. The preview invitation button 671 generates a preview of the electronic message that would be sent to the user.

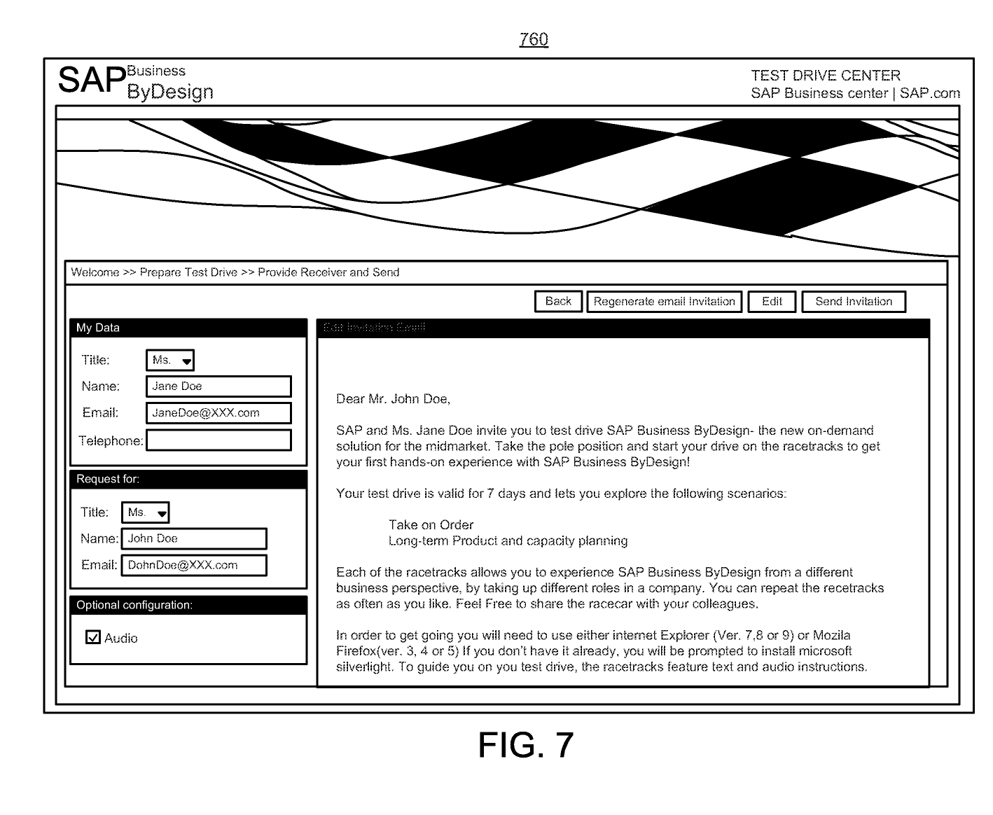

Referring to FIG. 7, an exemplary screenshot illustrates an example of the draft invitation electronic message 760. The electronic message 760 is generated from the screens 550A and 550B and incorporates the information from the requestor area and the receiver area. The draft electronic message gives the requestor an opportunity to edit the invitation email and to send the invitation to the prospective customer.

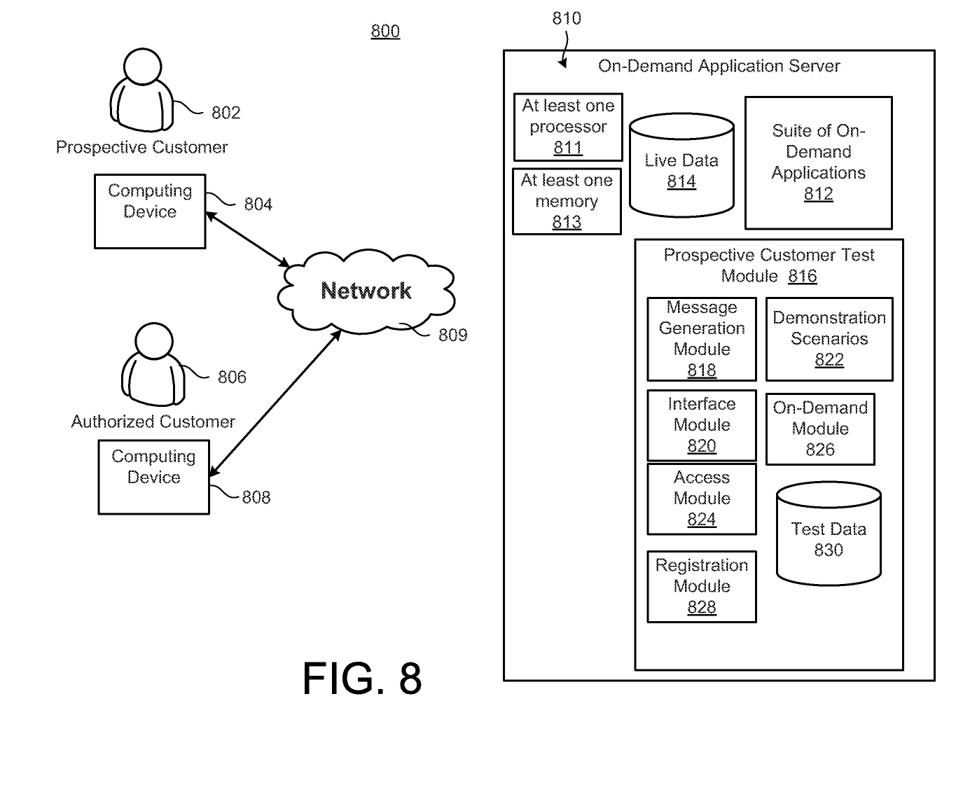

Referring to FIG. 8, an exemplary block diagram illustrates a system for enabling prospective customers of a remotely hosted, on-demand computer application to test the on-demand computer application. For example, a prospective customer 802 may use a computing device 804. Either the prospective customer 804 or an authorized customer 806 using computer device 808 may access the on-demand application 810 through the network 809. The computing device 804 and the computing device 808 may be any type of computing device that includes at least one processor and at least one memory and one or more applications including, for example, a browser application. The browser application may be the application to enable either the prospective customer 802 or the authorized customer 806 to register for access to the prospective customer module to test the on-demand application 810.

The network may be any type of network including the internet. The on-demand application 810 may include a suite of applications that are located on at least one remotely hosted server. The on-demand application may be hosted on multiple servers where the suite of on-demand applications 812 may be located across the various servers, which are accessible through the network 809. The on-demand application server 810 may include at least one processor 811 and at least one memory device 813. The at least one processor 811 may be configured to execute instructions stored on the at least one memory 813 to perform the various functions associated with the on-demand applications 812. The various components in the on-demand application server 810 may be interconnected such that the components may communicate with one another. While the components are shown as modules, one or more of the different modules may be arranged and configured in other configurations other than what is shown in FIG. 8.

The on-demand application server 810 includes a live data database 814. The live data 814 contains the data for use by authorized customers 806 when they use the suite of on-demand applications 812. The on-demand application server also may include a prospective customer test module 816. The prospective customer test module 816 may include multiple modules and provide the functionality to allow users and prospective customers to register for access to demonstration scenarios that utilize the suite of on-demand applications 812. The prospective customer test module 816 may include a message generation module 818, an interface module 820, demonstration scenarios 822, access module 824, on-demand module 826, registration module 828 and test data 830.

The message generation module 818 may be configured to generate and send an electronic message containing at least one selectable link. The selectable link may be unique to an identified prospective customer, such as, prospective customer 802. The selectable link may enable access to the on-demand application server 810. The selectable link allows the prospective customer 802 to access the suite of on-demand applications 812. Multiple different prospective customers may each be sent a unique selectable link that is generated by the message generation module that allows each prospective customer access to the on-demand application server 810. In one exemplary implementation, the selectable link provides access without requiring a user name and/or a password. The message generation module 818 may generate the electronic message 460 that includes the selectable link 462 of FIG. 4.

The interface module 820 may be configured to present an interface to the identified prospective customer 802 in response to receiving a selection of the selectable link contained in the electronic message. For example, the interface module 820 may be configured to present the interface 100 of FIG. 1 to the prospective customer 802. As discussed above with respect to FIG. 1 and exemplary screenshot of the interface 200 of FIG. 2, the interface includes an information area and a selection area.

The access module 824 may be configured to grant access to the selected demonstration scenario located on the on-demand application server 810. This would be in response to receiving a selection of one of the selectable URLs presented by the interface module on the interface screen to the prospective customer. The on-demand module 826 may be configured to utilize the suite of on-demand application 812 to run the selected demonstration scenario. As discussed above, the demonstration scenario may be either a live access scenario, an interactive process recording scenario, or a combination of live access and a scripted interactive process recording. For the live access demonstration scenarios, the test data 830 may be utilized in order to provide context and data for the selected demonstration scenario.

The access module 824 may be configured to grant access to the selected demonstration scenario without requiring a user identification and/or a password. The on-demand application server 810 may be the same server that is utilized by both prospective customers, such as prospective customers 802 as well as authorized customers 806, to run the suite of on-demand applications 812.

The prospective customer test module 816 also may include a registration module 828. The registration module 828 may be configured to provide an interface to either an authorized customer or a prospective customer to enable those individuals to select one or more demonstration scenarios to cause the message generation module 818 to generate and send the electronic message to the identified prospective customer. For example, the registration module may be configured to provide the interface such as the interface 450 of FIG. 4.

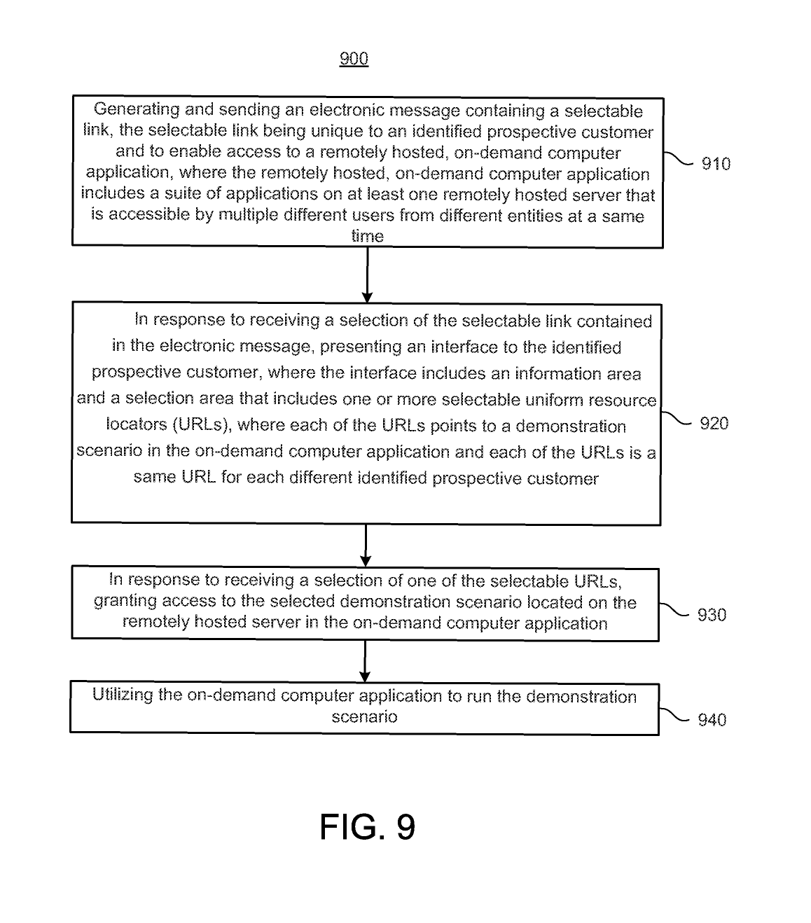

Referring to FIG. 9, an exemplary process 900 illustrates techniques for utilizing the systems described above including, for example, the system 800 of FIG. 8. Process 900 may include generating and sending an electronic message containing a selectable link (910). The selectable link may be unique to an identified prospective customer and may enable access to a remotely hosted, on-demand computer application, where the remotely hosted, on-demand computer application includes a suite of applications on at least one remotely hosted server that is accessible by multiple different users from different entities at a same time. For example, as discussed above with respect to FIG. 8, the message generation module 818 may be configured to generate and send the electronic message that contains the selectable link. The selectable link is unique to the identified prospective customer.

In response to receiving a selection of the selectable link contained in the electronic message, an interface may be presented to the identified prospective customer (920). For example, the interface module 820 may present the interface to the identified prospective customer in response to receiving the selection of the selectable link contained in the electronic message. As discussed above, the interface includes an information area and a selection area that includes one or more selectable URLs, where each of the URLs points to a demonstration scenario in the on-demand computer application and each of the URLs is a same URL for each different identified prospective customer. In this manner, the generation of the demonstration scenarios and the setup of the interface are made easier by developers because the same URL is used for each of the demonstrations scenarios. The demonstration scenarios are, for example, the ones as illustrated in the selection area 204 of FIG. 2.

In response to receiving a selection of one of the selectable URLs, access may be granted to the selected demonstration scenario located on the remotely hosted server in the on-demand computer application (930). For example, the access module 824 of FIG. 8 may grant access to the selected demonstration scenario located on the on-demand application server 810 in response to receiving a selection of one of the selectable URLs.

The on-demand computer application may be utilized to run the demonstration scenario (940). For example, the on-demand module 826 may be used to run the selected demonstration scenario using the suite of on-demand applications 812 and the test data 830.

Implementations of the various techniques described herein may be implemented in digital electronic circuitry, or in computer hardware, firmware, software, or in combinations of them. Implementations maybe implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for allowing prospective customers of a remotely hosted, on-demand computer application to test the on-demand computer application, the method comprising:
generating and sending an electronic message containing a selectable link, the selectable link being unique to an identified prospective customer and to enable access to a remotely hosted, on-demand computer application, wherein the remotely hosted, on-demand computer application includes a suite of applications on at least one remotely hosted server that is accessible by multiple different users from different entities at a same time;
in response to receiving a selection of the selectable link contained in the electronic message, presenting an interface to the identified prospective customer, wherein the interface comprises:
an information area; and
a selection area comprising one or more selectable uniform resource locators (URLs), wherein each of the URLs points to a demonstration scenario in the on-demand computer application and each of the URLs is a same URL for each different identified prospective customer;
in response to receiving a selection of one of the selectable URLs, granting access to the selected demonstration scenario located on the remotely hosted server in the on-demand computer application; and
utilizing the on-demand computer application to run the demonstration scenario.

2. The computer-implemented method of claim 1 wherein the on-demand computer application is a same on-demand computer application accessible by authorized customers.

3. The computer-implemented method of claim 1 wherein granting access to the selected demonstration scenario comprises granting access to the selected demonstration scenario without requiring a user identification and a password.

4. The computer-implemented method of claim 1 wherein the demonstration scenario comprises:
a guide area comprising information and click through steps to assist the prospective customer; and
an application area configured to provide live access to the on demand application as limited by the demonstration scenario.

5. The computer-implemented method of claim 1 wherein the demonstration scenario comprises:
a guide area comprising information and click through steps to assist the prospective customer; and
an application area configured to provide an interactive process recording to simulate the on demand application as limited by the demonstration scenario.

6. The computer-implemented method of claim 1 further comprising:
providing an interface to an authorized customer to enable the authorized customer to select one or more demonstration scenarios to cause the generating and sending of the electronic message to the identified prospective customer.

7. The computer-implemented method of claim 1 further comprising:
providing an interface to the identified prospective customer to enable the identified prospective customer to select one or more demonstration scenarios to cause the generating and sending of the electronic message to the identified prospective customer.

8. A computer-readable storage medium storing instructions that, when executed, cause a processor to perform a process, the instructions comprising instructions to:
generate and send an electronic message containing a selectable link, the selectable link being unique to an identified prospective customer and to enable access to a remotely hosted, on-demand computer application, wherein the remotely hosted, on-demand computer application includes a suite of applications on at least one remotely hosted server that is accessible by multiple different users from different entities at a same time;
in response to receiving a selection of the selectable link contained in the electronic message, present an interface to the identified prospective customer, wherein the interface comprises:
an information area; and
a selection area comprising one or more selectable uniform resource locators (URLs), wherein each of the URLs points to a demonstration scenario in the on-demand computer application and each of the URLs is a same URL for each different identified prospective customer;
in response to receiving a selection of one of the selectable URLs, grant access to the selected demonstration scenario located on the remotely hosted server in the on-demand computer application; and
utilize the on-demand computer application to run the demonstration scenario.

9. The computer-readable storage medium of claim 8 wherein the on-demand computer application is a same on-demand computer application accessible by authorized customers.

10. The computer-readable storage medium of claim 8 wherein the instructions to grant access to the selected demonstration scenario comprises instructions to grant access to the selected demonstration scenario without requiring a user identification and a password.

11. The computer-readable storage medium of claim 8 wherein the demonstration scenario comprises:
a guide area comprising information and click through steps to assist the prospective customer; and
an application area configured to provide live access to the on demand application as limited by the demonstration scenario.

12. The computer-readable storage medium of claim 8 wherein the demonstration scenario comprises:
a guide area comprising information and click through steps to assist the prospective customer; and
an application area configured to provide an interactive process recording to simulate the on demand application as limited by the demonstration scenario.

13. The computer-readable storage medium of claim 8 wherein the instructions further comprise instructions to:
provide an interface to an authorized customer to enable the authorized customer to select one or more demonstration scenarios to cause the generating and sending of the electronic message to the identified prospective customer.

14. The computer-readable storage medium of claim 8 wherein the instructions further comprise instructions to:
provide an interface to the identified prospective customer to enable the identified prospective customer to select one or more demonstration scenarios to cause the generating and sending of the electronic message to the identified prospective customer.

15. A computer system including instructions recorded on a computer-readable medium and executable by at least one processor, the system comprising:
a message generation module configured to generate and send an electronic message containing a selectable link, the selectable link being unique to an identified prospective customer and to enable access to a remotely hosted, on-demand computer application, wherein the remotely hosted, on-demand computer application includes a suite of applications on at least one remotely hosted server that is accessible by multiple different users from different entities at a same time;
an interface module configured to present an interface to the identified prospective customer in response to receiving a selection of the selectable link contained in the electronic message, wherein the interface comprises:
an information area; and
a selection area comprising one or more selectable uniform resource locators (URLs), wherein each of the URLs points to a demonstration scenario in the on-demand computer application and each of the URLs is a same URL for each different identified prospective customer;
an access module configured to grant access to the selected demonstration scenario located on the remotely hosted server in the on-demand computer application in response to receiving a selection of one of the selectable URLs; and
an on-demand module configured to utilize the on-demand computer application to run the demonstration scenario.

16. The computer system of claim 15 wherein the on-demand computer application is a same on-demand computer application accessible by authorized customers.

17. The computer system of claim 15 wherein the access module is configured to grant access to the selected demonstration scenario without requiring a user identification and a password.

18. The computer system of claim 15 wherein the demonstration scenario comprises:
a guide area comprising information and click through steps to assist the prospective customer; and
an application area configured to provide live access to the on demand application as limited by the demonstration scenario.

19. The computer system of claim 15 wherein the demonstration scenario comprises:
a guide area comprising information and click through steps to assist the prospective customer; and
an application area configured to provide an interactive process recording to simulate the on demand application as limited by the demonstration scenario.

20. The computer system of claim 15 further comprising:
a registration module configured to provide an interface to an authorized customer to enable the authorized customer to select one or more demonstration scenarios to cause the message generation module to generate and send the electronic message to the identified prospective customer.
